(19) United States
(12) Patent Application Publication
(10) Pub. No.: US 2016/0125337 A1
(43) Pub. Date: May 5, 2016

(54) TRANSACTION DERIVED IN-BUSINESS PROBABILITY MODELING APPARATUS AND METHOD

(71) Applicant: MasterCard International Incorporated, Purchase, NY (US)

(72) Inventors: Cristobel Kay von Walstrom, Greenwich, CT (US); Bruce William Mac Nair, Stamford, CT (US); Annabel Truscott, Ossining, NY (US); Gene K. Corcoran, Larchmont, NY (US); Ashwath Murali, New York, NY (US)

(21) Appl. No.: 14/879,717

(22) Filed: Oct. 9, 2015

Related U.S. Application Data
(60) Provisional application No. 62/061,895, filed on Oct. 9, 2014.

(51) Int. Cl. G06Q 10/06

(52) U.S. Cl. CPC G06Q 10/06313

(57) ABSTRACT

A system, method, and computer-readable storage medium configured to process, analyze, and model of large amounts of data resulting in improved functionality over a generic computer.

### RELATED APPLICATIONS

This application claims priority to U.S. Provisional Patent Application 62/061,895 filed on Oct. 9, 2014, entitled “Transaction Derived In-Business Probability Apparatus and Method.”

### BACKGROUND

1. Field of the Disclosure

Aspects of the disclosure relate in general to financial services. Aspects include an apparatus, system, method and computer-readable storage medium to process, analyze, and model of large amounts of data resulting in improved functionality over a generic computer.

2. Description of the Related Art

In the technical fields of computer analytics and operations research, pattern detection includes a number of methods for extracting meaning from large and complex data sets through a combination of operations research methods, graph theory, data analysis, clustering, and advanced mathematics.

Unlike machine learning, deep learning, or data mining, pattern detection is data agnostic, requiring only an ingestible data format to compute correlations in data.

Graph algorithms detect patterns of co-occurrence to create a holistic representation of connections a given set of data. Analysis has been applied to industries including transportation, manufacturing, and other fields, such as computer science.

Another different area of technology is computer modeling or computer simulation.

A computer simulation is a simulation, run on a single computer, or a network of computers, to reproduce behavior of a system. The simulation uses an abstract model (a computer model, or a computational model) to simulate the system. Computer simulations have become a useful part of mathematical modeling of many natural systems in physics (computational physics), astrophysics, climatology, chemistry and biology, human systems in economics, psychology, social science, and engineering. Simulation of a system is represented as the running of the system's model. It can be used to explore and gain new insights into new technology and to estimate the performance of systems too complex for analytical solutions.

Computer simulations vary from computer programs that run a few minutes to network-based groups of computers running for hours to ongoing simulations that run for days. The scale of events being simulated by computer simulations has far exceeded anything possible (or perhaps even imaginable) using traditional paper-and-pencil mathematical modeling. Over 10 years ago, a desert-battle simulation of one force invading another involved the modeling of 66,239 tanks, trucks and other vehicles on simulated terrain around Kuwait, using multiple supercomputers in the Department of Defense High Performance Computer Modernization Program. Other computer modeling examples include: a billion-atom model of material deformation, a 2.64-million-atom model of the complex maker of protein in all organisms called a “ribosome,” a complete simulation of the life cycle of mycoplasma genitalium, and the “Blue Brain” project at the École Polytechnique Fédérale de Lausanne (EPFL) in Switzerland to create the first computer simulation of the entire human brain, right down to the molecular level.

In an entirely different field, for centuries financial transactions have used currency, such as banknotes and coins. For example, traditionally, whenever travelers leave home, they carried to pay for expenses, such as shopping, transportation, lodging, and food.

In modern times, however, payment cards are rapidly replacing cash to facilitate payments. Payment cards provide the clients of a financial institution (“cardholders”) with the ability to pay for goods and services without the inconvenience of using cash. A payment card is a card that can be used by a cardholder and accepted by a merchant to make a payment for a purchase or in payment of some other obligation. Payment cards include credit cards, debit cards, charge cards, and Automated Teller Machine (ATM) cards.

Payment cards eliminate the need for carrying large amounts of currency. Moreover, in international travel situations, payment cards obviate the hassle of changing currency.

There are over ten million merchant locations in the United States. Throughout the entire world, there are an even greater number of merchant locations. Some merchants are seasonal. Other merchants are open sporadically. While some merchants publish whether they are in-business on a web-site, or make this information available via the telephone, many merchants do not update this information, especially if they are going out of business. Moreover, due to the sheer number of merchants, it is a costly and difficult task to manually determine whether a company is open and in business.

### SUMMARY

Embodiments include a system, device, method and computer-readable medium to determine the probability of a business being open.

A modeling apparatus embodiment comprises a network interface, a non-transitory computer-readable storage medium, and a processor. The network interface receives a first merchant location specified by a first merchant identifier. The non-transitory computer-readable storage medium stores a transaction database. The processor retrieves from the transaction database transaction records for the first merchant location specified by the first merchant identifier. The transaction records include: time and date of transactions. The processor aggregates the transaction records by organizing the transaction by time-series slices, to detect time-based behavior from the time-series slices. The non-transitory computer-readable storage medium is further configured to store the time-based behavior in a merchant model.

### BRIEF DESCRIPTION OF THE DRAWINGS

FIG. 1 illustrates an embodiment of a system to determine the probability of a business being open using financial transactions with a payment network.

FIG. 2 is a block diagram of an in-business calculation server configured to determine the probability of a business being open using financial transactions with a payment network.

FIG. 3 illustrates a timeline with a snapshot date (T) with N-slices.

FIGS. 4A-D illustrate example transaction patterns for a variety of merchants.

### DETAILED DESCRIPTION

Aspects of the disclosure include a specialized computing device that results in greater data and information processing functionality when compared to a generic computer. Embodiments overcome a technical problem specifically arising in the realm of computer science and specify how interactions between elements are manipulated to yield a non-routine and non-conventional result, specifying how various databases and specific information are used to generate very specific information, resulting in the improved functionality.

Another aspect of the disclosure includes the understanding that many merchants accept payment accounts for transactions.

A further aspect of the disclosure is the realization that payment account financial transactions may be used to determine whether a merchant is open for business.

Embodiments of the present disclosure include a system, method, and computer-readable storage medium configured to determine the probability of a business being open using financial transactions with a payment network.

These and other aspects may be apparent in hindsight to one of ordinary skill in the art.

For the purposes of this disclosure, a payment account includes a stored-value account (such as a transit card or gift card), credit card account, debit card account, automatic teller machine (ATM) account, charge card account, electronic wallet, Radio Frequency Identifier (RFID) device, cloud-based payment device, checking account, savings account, or any other electronic payment device account known in the art.

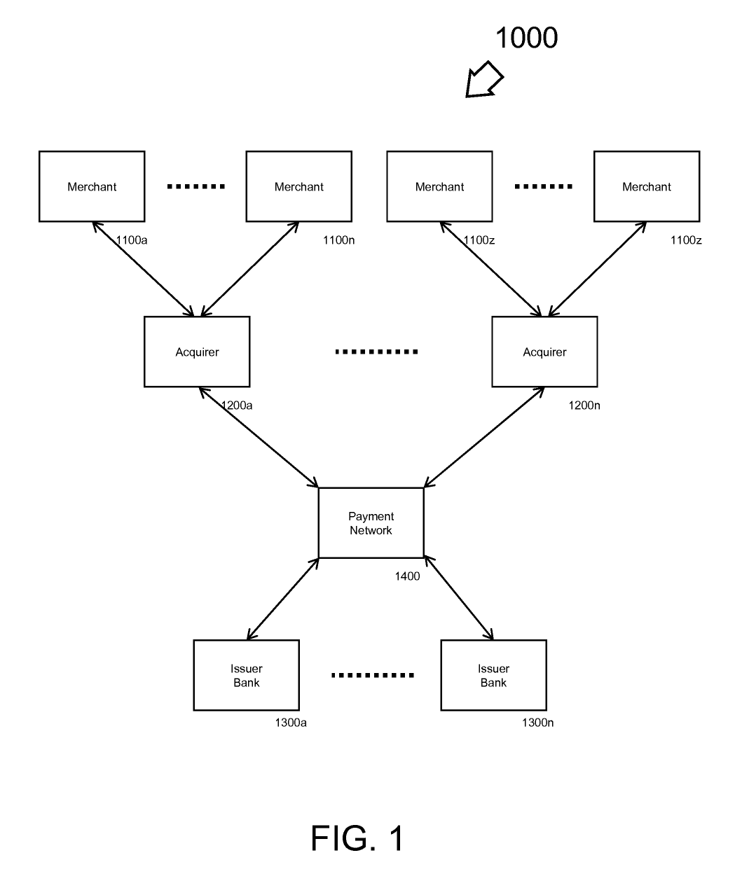

Payment accounts are affiliated with payment networks, which are operational networks that enable monetary exchange between parties. An example payment network includes MasterCard International Incorporated of Purchase, New York. FIG. 1 illustrates an embodiment of a system 1000 configured to determine merchant business hours using financial transactions with a payment network 1400, constructed and operative in accordance with an embodiment of the present disclosure. As shown in FIG. 1, a payment network 1400 may be coupled to numerous merchants 1100a-z via acquirer financial institutions 1200a-n. During a typical financial transaction, a customer pays for a product or service at a merchant 1100. The merchant 1100 either directly contacts the payment network 1400, or (as shown in FIG. 1) contacts the payment network 1400 via its acquirer financial institution 12000 for approval or decline of the transaction. Most of the time the payment network 1400 contacts the issuer 1300 of the payment account to determine the credit worthiness of the cardholder in determining the approval or decline. There may be more than one issuer 1300a-n in such a system 1000. A record of the authorization of the transaction is recorded at the payment network 1400. The recorded authorization information includes the merchant, the payment account information, and the time/date of the transaction.

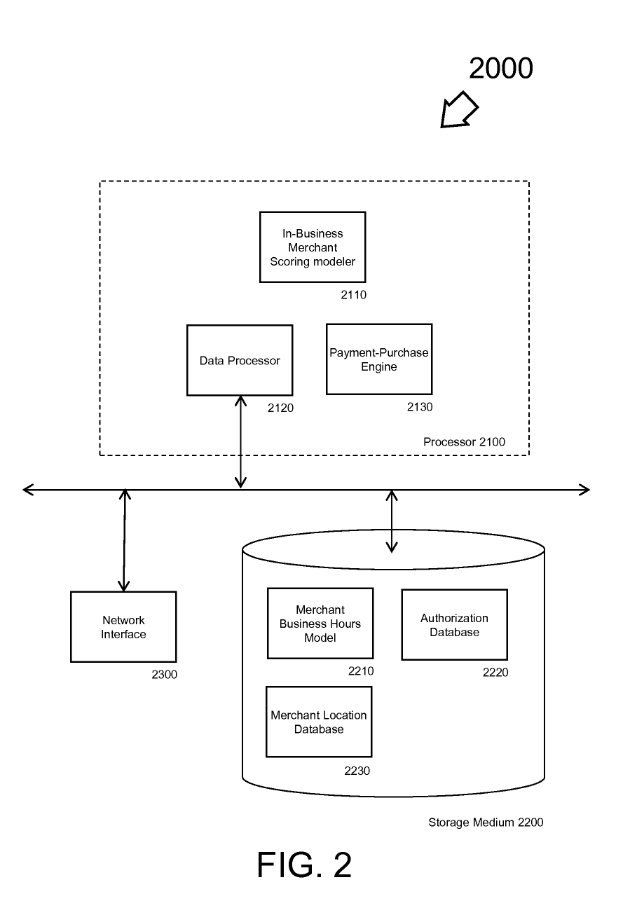

FIG. 2 is a block diagram of an in-business calculation server 2000 configured to determine the probability of a business being open using financial transactions with a payment network, constructed and operative in accordance with an embodiment of the present disclosure. In some embodiments, the computing device may be located at the payment network 1400 or at an issuer 1300. For the sake of illustration only, an embodiment will be described in which the in-business calculation server resides at the payment network 1400. The in-business calculation server 2000 comprises a processor, a network interface, and a non-transitory computer-readable storage medium.

In-business calculation server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may communicate with and temporarily store information in Random Access Memory (RAM) (not shown).

As shown in FIG. 2, processor 2100 is functionally comprised of an in-business merchant scoring modeler 2110, a payment-purchase engine 2130, and a data processor 2120.

In-business merchant scoring modeler 2110 is the structure that enables the in-business calculation server 2000 to analyze financial transactions and determine the in-business probability of a merchant 1100 based on the date/timing of the financial transactions. The in-business merchant scoring modeler 2110 creates a merchant model 2210, which results in a probability of whether a merchant is open. The functionality of in-business merchant scoring modeler 2110 is described in greater detail below.

Payment-purchase engine 2130 may be any structure that facilitates payment from customer accounts at an issuer 2300 to a merchant 1100. As described above, the customer accounts may include payment card accounts, checking accounts, savings accounts and the like.

Data processor 2120 enables processor 2100 to interface with storage medium 2200, network interface 2300 or any other component not on the processor 2100. The data processor 2120 enables processor 2100 to locate data on, read data from, and writes data to these components.

These structures may be implemented as hardware, firmware, or software encoded on a computer readable medium, such as storage medium 2200. Further details of these components are described with their relation to method embodiments below.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows in-business calculation server 2000 to communicate with vendors, cardholders, and/or issuer financial institutions.

Computer-readable storage medium 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain a merchant business hours database 2210, authorization database 2220, and merchant location database 2230.

Merchant business hours model 2210 is the data structure that models merchant in-business probability, as created or determined by in-business merchant scoring modeler 2110.

Authorization database 2220 may be a linked-list, table, or any data structure known in the art that contains a record of payment account financial transactions. Each record contains the details of a financial transaction, and includes a merchant identifier, the payment account information, and the time/date of the transaction. The merchant identifier is an identifier indicating which merchant store the transaction took place. The payment account information is a payment account indicator, such as a Primary Account Number (PAN), hashed Primary Account Number or other indicator.

Merchant location database 2230 may be any data structure in the art that contains geographic information for a merchant 1100. The geographic information for merchant 1100 may include the time zone in which the merchant is located.

These structures may be implemented as hardware, firmware, or software encoded on a non-transitory computer readable medium, such as storage media. Further details of these components are described with their relation to method embodiments below.

It is understood by those familiar with the art that one or more of these databases 2210-2230 may be combined in a myriad of combinations.

These structures may be implemented as hardware, firmware, or software encoded on a non-transitory computer readable medium, such as storage media. Further details of these components are described with their relation to method embodiments below.

In at least one embodiment, the in-business merchant scoring modeler 2110 incorporates a merchant business hours model 2210. Such an embodiment may replace “Yes/No” flags with a probability that a given merchant 1100 location will see a transaction within a certain future time period. In addition, the merchant business hours model 2210 identifies any strong seasonal patterns and creates one or more additional flags indicating that a merchant 1100 might not see a transaction within the forecast period but would still be expected to see transactions at some point in the future.

The in-business merchant scoring modeler 2110 retrieves aggregated transactions for at least one merchant location (usually specified by the merchant identifiers) from over a set-time period from an authorization database 2220. Alternatively, in some embodiments in-business merchant scoring modeler 2110 retrieves transactions for at least one merchant location from an authorization database 2220, and aggregates the transactions.

The in-business merchant scoring modeler 2110 reviews transaction patterns from the aggregated transactions to determine the types of patterns that are observed. The various types of patterns addressed by an in-business merchant scoring modeler 2110 are identified. The in-business merchant scoring modeler 2110 develops predictive model showing likelihood of a transaction occurring at a given location within a certain period of time. Such a merchant business hours model 2210 may then be stored on storage medium 2200.

Given a set of merchant 1100 locations received from another computer via a network interface 2300, the in-business merchant scoring modeler 2110 matches clearing transaction data retrieved from the authorization database 2220 to each location (retrieved from merchant location database 2230) such that every location has time-series ‘slices’ of aggregated transaction data. These slices represent the independent variables in the merchant scoring modeler 2110 and can be constructed in a variety of ways. A variable may capture spend in the last day, spend in the last week, spend in the last month, spend in the last 3 months, and the like. The slices are generated via the in-business merchant scoring modeler 2110 as numerous mathematically transformed variables using the entire universe of transaction data will be used to detect different seasonality patterns.

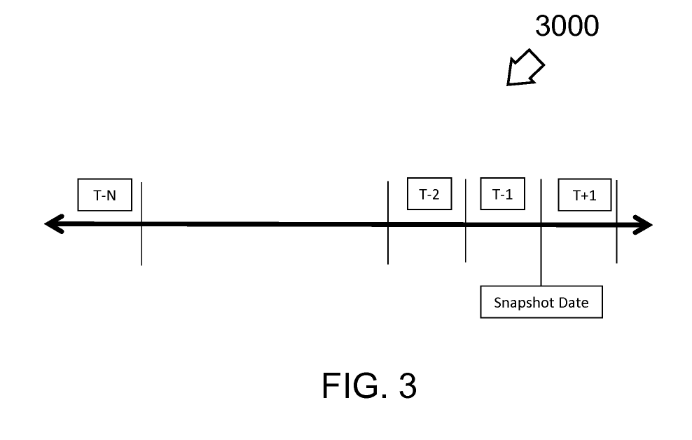

An example snapshot date “T” with N-slices is shown in FIG. 3, constructed and operative in accordance with an embodiment of the present disclosure. As shown, an N-number of time-series slices of aggregated transaction data can be found.

Additional variables used may be location-based variables that represent a merchant's proximity, as determined by merchant location database 2230, to other businesses that have already been classified as seasonal. In such an embodiment, the in-business merchant scoring modeler 2110 uses the merchant identifier to search merchant location database 2230 to resolve the geographic location of the merchant 1100. From the resolved geographic location, proximately located other businesses can be determined. This factor allows the in-business merchant scoring modeler 2110 to score new seasonal merchants without or in addition to the transaction history used to create the time slice variables. Proximately located businesses would generally be located near the merchant. For example, if the merchant 1100 were a beach-located business, the proximately located businesses would also be located near the beach. In some instances, proximate distances vary depending upon the geographic location of the merchant 1100. For example, proximate distances may be measured in blocks, miles (or fraction thereof), or kilometers (or fraction thereof) away.

Based on merchant characteristics and pattern analysis of the variables described above, multiple merchant business hours models 2210 may be used for the optimal predictive power given the variance in transaction patterns. ‘Limited dependent variable’ models ensure the scoring produces a probabilistic output between 0 and 1.

Different merchant business hours models 2210 may exist for different types of merchant transaction patterns. Predictive time periods may be different for different types of merchants 1100, and may require an additional variable to indicate the time period.

Additionally, in-business merchant scoring modeler 2110 may use seasonal business flags to indicate that a business location may be closed for a certain period of time, but is expected to be active at a future time beyond the predictive window.

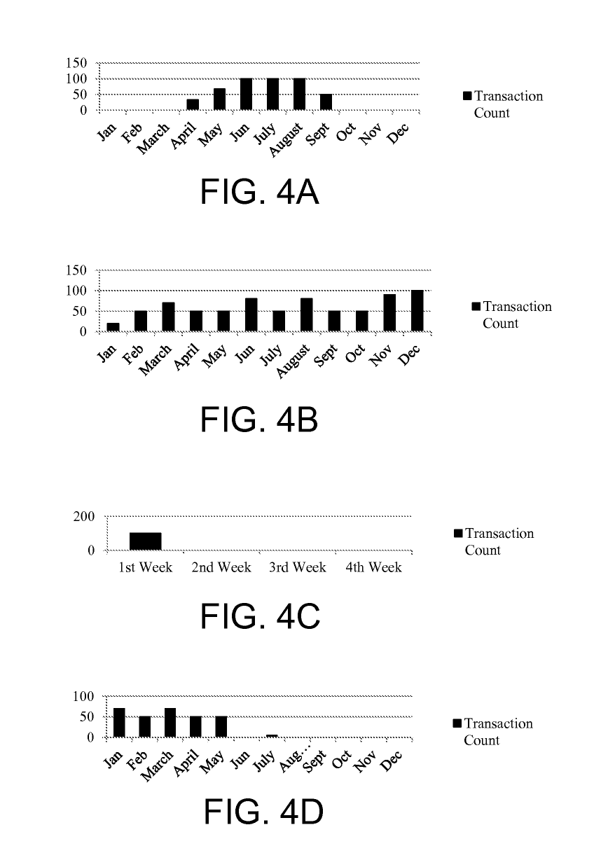

A typical merchant dataset comprises of many, different types of business and transaction patterns. FIGS. 4A-D illustrate example transaction patterns for a variety of merchants, constructed and operative in accordance with an embodiment of the present disclosure.

As shown in FIG. 4A, there may be seasonal merchants, which operate in only discrete times of the year. An example of a seasonal business includes a summer-time ice cream stand. As shown, such an ice cream stand may only have transactions from April through September. Other merchants may operate continuously, such as a “big box” retailer, as seen in FIG. 4B. Such a merchant exhibits transactions throughout the year. Some merchants operate on a subscription basis, and all their transactions occur only in some parts of the month, as seen in FIG. 4C. Finally, some merchants are going out of business. An example is shown in FIG. 4D, where the merchant was closed in June, but had trickle-over effects in transaction volume leading into July. In-business merchant scoring modeler 2110 marks the merchant as closed at the proper time due to pattern analysis, but a filter approach would see the transaction in July and indicate the merchant was still open.

In-business merchant scoring modeler 2110 embodiments analyze all transaction data at each merchant to determine whether seasonality or event driven effects exist and modify the businesses likelihood score accordingly. This radically improves on a simple binary approach of setting an in-business flag based monitor.

Using the output of the merchant business hours model 2210, scores between 0 and 1 (or likewise 0 and 100) are be appended to each merchant location record to create an output dataset of ‘Transaction Derived In-business Probability Scores’ which can be used for the various applications described in the IDF (mapping, business listings, and the like).

To enable the embodiments described, it is understood that hardware, software, and firmware encoded on to non-transitory computer readable media are utilized.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and features disclosed herein.

What is claimed is:

1. An modeling method comprising:
receiving, with a network interface, a first merchant location specified by a first merchant identifier;
retrieving from a transaction database stored on non-transitory computer-readable storage medium transaction records for the first merchant location specified by the first merchant identifier, the transaction records including: time and date of transactions;
aggregating the transaction records by organizing the transaction by time-series slices with a processor;
detecting, with the processor, time-based behavior from the time-series slices;
storing the time-based behavior in a merchant model on the non-transitory computer-readable storage medium.

2. The modeling method of claim 1, wherein the detecting time-based behavior further comprises:
resolving a first geographic location of the first merchant location from a geographic database stored on the non-transitory computer-readable storage medium;
determining, with the processor, other business locations proximate to the first geographic location;
detecting, with the processor, time-based behavior from the other business locations.

3. The modeling method of claim 2, wherein the time-series slices are daily.

4. The modeling method of claim 2, wherein the time-series slices are weekly.

5. The modeling method of claim 2, wherein the time-series slices are hourly.

6. The modeling method of claim 2, wherein the determining other business locations proximate to the first geographic location is accomplished by distance away from the first geographic location.

7. The modeling method of claim 6, wherein the distance is a mile or less.

8. A modeling apparatus comprising:
a network interface configured to receive a first merchant location specified by a first merchant identifier;
a non-transitory computer-readable storage medium configured to store a transaction database;
a processor configured to retrieve from the transaction database transaction records for the first merchant location specified by the first merchant identifier, the transaction records including: time and date of transactions, to aggregate the transaction records by organizing the transaction by time-series slices, to detect time-based behavior from the time-series slices; and
the non-transitory computer-readable storage medium is further configured to store the time-based behavior in a merchant model.

9. The modeling apparatus of claim 8, wherein the detecting time-based behavior further comprises:
resolving a first geographic location of the first merchant location from a geographic database stored on the non-transitory computer-readable storage medium;
determining, with the processor, other business locations proximate to the first geographic location;
detecting, with the processor, time-based behavior from the other business locations.

10. The modeling apparatus of claim 9, wherein the time-series slices are daily.

11. The modeling apparatus of claim 9, wherein the time-series slices are weekly.

12. The modeling apparatus of claim 9, wherein the time-series slices are hourly.

13. The modeling apparatus of claim 9, wherein the determining other business locations proximate to the first geographic location is accomplished by distance away from the first geographic location.

14. The modeling apparatus of claim 13, wherein the distance is a mile or less.

15. A modeling apparatus comprising:
means for receiving a first merchant location specified by a first merchant identifier;
means for retrieving from a transaction database transaction records for the first merchant location specified by the first merchant identifier, the transaction records including: time and date of transactions;
means for aggregating the transaction records by organizing the transaction by time-series slices;
means for detecting time-based behavior from the time-series slices;
means for storing the time-based behavior in a merchant model.

16. The modeling apparatus of claim 15, wherein the means for detecting time-based behavior further comprises:
means for resolving a first geographic location of the first merchant location from a geographic database;
means for determining other business locations proximate to the first geographic location;
means for detecting time-based behavior from the other business locations.

17. The modeling apparatus of claim 16, wherein the time-series slices are daily.

18. The modeling apparatus of claim 16, wherein the time-series slices are weekly.

19. The modeling apparatus of claim 16, wherein the time-series slices are hourly.

20. The modeling apparatus of claim 16, wherein the determining other business locations proximate to the first geographic location is accomplished by distance away from the first geographic location.
